(19) United States
(12) Patent Application Publication
(10) Pub. No.: US 2019/0118776 A1
(43) Pub. Date: Apr. 25, 2019

(54) VEHICLE WINDOW CLEANING

(71) Applicant: Ford Global Technologies, LLC, Dearborn, MI (US)

(72) Inventors: Venkatesh Krishnan, Canton, MI (US); Segundo Baldovino, Novi, MI (US); Andre Sykula, Sterling Heights, MI (US)

(73) Assignee: Ford Global Technologies, LLC, Dearborn, MI (US)

(21) Appl. No.: 15/788,697

(22) Filed: Oct. 19, 2017

(51) Int. Cl. B60S 1/08; B60S 1/48; G07C 5/00

(52) U.S. Cl. CPC B60S 1/0807; B60S 1/0844; G07C 5/008; B60S 1/485; B60S 1/0862

(57) ABSTRACT

A system includes a computer including a processor and a memory, the memory storing instructions executable by the processor to actuate a windshield wiper on a vehicle, collect amplitude data and frequency data from a sound of the windshield wiper, and, upon determining that the amplitude data meets a first predetermined threshold and the frequency data meets a second predetermined threshold, actuate a vehicle component to move the vehicle to a specified location.

### BACKGROUND

Vehicles can include sensors to collect data of a surrounding environment. The sensors can be placed on various parts of the vehicle, e.g., a vehicle roof, a vehicle hood, a rear vehicle door, etc. The sensors may become dirty during operation of the vehicle. However, the vehicle windshield may become dirty during operation of the vehicle as well. It is a problem to effectively clean sensors and/or sensor lenses or covers, especially when sensor data and/or environmental conditions around a vehicle can be changing and changes can affect sensor operation.

### BRIEF DESCRIPTION OF THE DRAWINGS

FIG. 1 is a block diagram of an example system for cleaning a vehicle.

FIG. 2 is an isometric view of the vehicle including sensors.

FIG. 3 is a block diagram of a computer communicating with vehicle components.

FIG. 4 illustrates an example microphone installed in the vehicle.

FIG. 5 illustrates an example process for cleaning the vehicle.

### DETAILED DESCRIPTION

A system includes a computer including a processor and a memory, the memory storing instructions executable by the processor to actuate a windshield wiper on a vehicle, collect amplitude data and frequency data from a sound of the windshield wiper, and upon determining that the amplitude data meets a first predetermined threshold and the frequency data meets a second predetermined threshold, actuate a vehicle component to move the vehicle to a specified location.

The instructions can further include instructions to actuate the windshield wiper upon detecting rain.

The instructions can further include instructions to capture an image of a windshield and, upon detecting dirt on the windshield, to actuate the vehicle component.

The instructions can further include instructions to receive instructions from a second computer to actuate the windshield wiper.

The instructions can further include instructions to actuate a fluid pump directed to a windshield.

The instructions can further include instructions to move the vehicle to the specified location upon detecting that a reservoir fluid level is below a reservoir level threshold.

The instructions can further include instructions to send a message including a vehicle maintenance request to the specified location.

The first predetermined threshold and the second predetermined threshold can be based on a sound generated by the windshield wiper on a windshield.

The instructions can further include instructions to actuate a microphone to collect the amplitude data and the frequency data upon detecting rain.

The instructions can further include instructions to receive a message from a second computer indicating a rain speed and to actuate the windshield wiper at a wiper speed based on the rain speed.

A system in a vehicle includes a windshield wiper, a microphone, means for actuating the windshield wiper, means for collecting amplitude data and frequency data from a sound of the windshield wiper with the microphone, and means for actuating a vehicle component to move the vehicle to a specified location upon determining that the amplitude data meets a first predetermined threshold and the frequency data meets a second predetermined threshold.

The system can further include means for actuating the windshield wiper upon detecting rain.

The system can further include means for capturing an image of a windshield and, upon detecting dirt on the windshield, to actuate the vehicle component.

The system can further include a fluid pump directed toward a windshield and means for actuating the fluid pump.

The system can further include means for moving the vehicle to the specified location upon detecting that a reservoir fluid level is below a reservoir level threshold.

The system can further include means for sending a message including a vehicle maintenance request to the specified location.

In the system, the first predetermined threshold and the second predetermined threshold can be based on a sound generated by the windshield wiper on a windshield.

The system can further include means for actuating the microphone upon detecting rain.

The system can further include means for receiving a message from a second computer indicating a rain speed and actuating the windshield wiper at a wiper speed based on the rain speed.

A method includes actuating a windshield wiper on a vehicle, collecting amplitude data and frequency data from a sound of the windshield wiper, and upon determining that the amplitude data meets a first predetermined threshold and the frequency data meets a second predetermined threshold, actuating a vehicle component to move the vehicle to a specified location.

Based on input via the microphone, the first computer and the second computer can determine whether the windshield is clean during a precipitation event and/or whether the windshield wipers are operational. Furthermore, the first computer can actuate vehicle components based on instructions from the second computer, and the second computer can generate the instructions upon request from the first computer, allowing the first computer and the second computer to conserve overall computing resources.

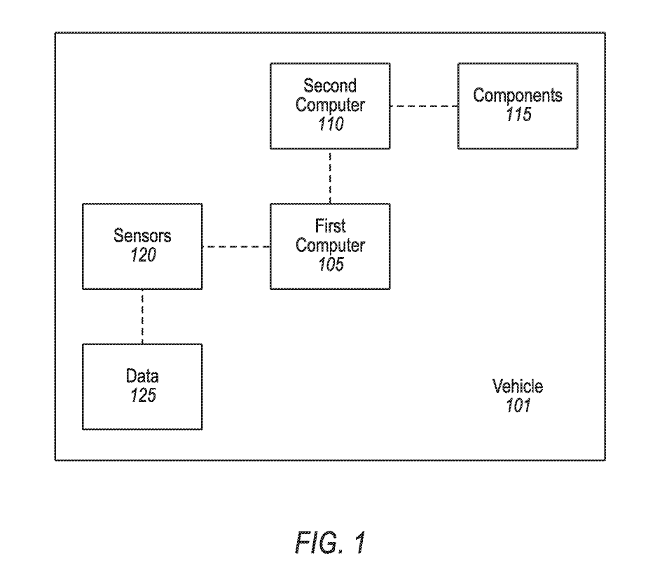

FIG. 1 illustrates an example system 100 for operating a vehicle 101. A first computer 105 in the vehicle 101 is programmed to actuate one or more vehicle components 115. A second computer 110 in the vehicle 101 is programmed to receive data 125 from one or more sensors 120. For example, vehicle 101 data 125 may include a location of the vehicle 101, data about an environment around a vehicle, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 125 can include measurements of vehicle 101 systems and components, e.g., a vehicle 101 velocity, a vehicle 101 trajectory, etc.

The computers 105, 110 are generally programmed for communications on a vehicle 101 network, e.g., including a communications bus, as is known. Via the network, bus, and/or other wired or wireless mechanisms (e.g., a wired or wireless local area network in the vehicle 101), the computers 105, 110 may transmit messages to various devices in a vehicle 101 and/or receive messages from the various devices, e.g., controllers, actuators, sensors, etc., including sensors 120. Alternatively or additionally, in cases where the computers 105, 110 actually comprise multiple devices, the vehicle network may be used for communications between devices represented as the computer 105 in this disclosure. In addition, the computers 105, 110 may be programmed for communicating with a network which may include various wired and/or wireless networking technologies, e.g., cellular, Bluetooth®, Bluetooth® Low Energy (BLE), wired and/or wireless packet networks, etc.

The vehicle 101 may include a plurality of vehicle components 115. As used herein, each vehicle component 115 includes one or more hardware components adapted to perform a mechanical function or operation—such as moving the vehicle, slowing or stopping the vehicle, steering the vehicle, etc. Non-limiting examples of components 115 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like.

Sensors 120 may include a variety of devices. For example, as is known, various controllers in a vehicle 101 may operate as sensors 120 to provide data 125 via the vehicle 101 network or bus, e.g., data 125 relating to vehicle speed, acceleration, position, subsystem and/or component status, etc. Further, other sensors 120 could include cameras, motion detectors, etc., i.e., sensors 120 to provide data 125 for evaluating a location of a target, projecting a path of a target, evaluating a location of a roadway lane, etc. The sensors 120 could also include short range radar, long range radar, LIDAR, and/or ultrasonic transducers.

Collected data 125 may include a variety of data collected in a vehicle 101. Examples of collected data 125 are provided above, and moreover, data 125 are generally collected using one or more sensors 120, and may additionally include data calculated therefrom in the computer 105, and/or at the server 130. In general, collected data 125 may include any data that may be gathered by the sensors 120 and/or computed from such data.

When the computers 105, 110 operate the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computers 105, 110. A semi-autonomous mode is one in which at least one of vehicle 101 propulsion (typically via a powertrain including an electric motor and/or internal combustion engine), braking, and steering are controlled at least partly by the computers 105, 110 as opposed to a human operator. In a non-autonomous mode, i.e., a manual mode, the vehicle 101 propulsion, braking, and steering are controlled by the human operator.

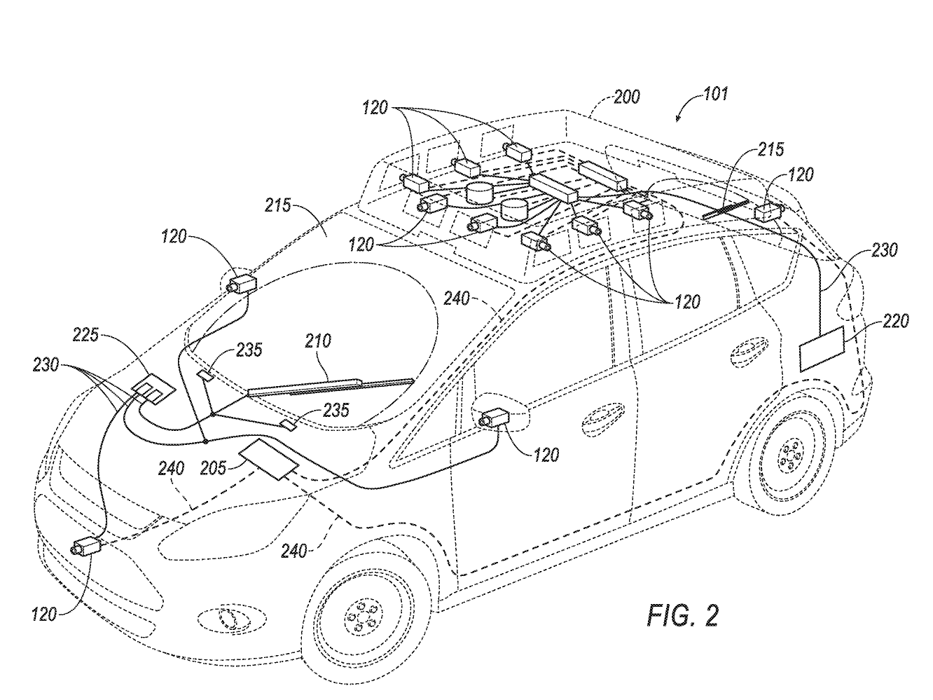

FIG. 2 illustrates an example vehicle 101. The vehicle 101 can include a sensor block 200. The sensor block 200 is a housing, support structure, or the like that can house a plurality of sensors 120, including one or more cameras 120 and lidars 120. The sensor block 200 can secure the sensors 120 in a specified orientation to collect data 125 in a specific direction relative to the vehicle 101. The sensor block 200 can be fixed to the vehicle 101 roof. The second computer 110 can collect data 125 from the sensors 120 to operate the vehicle 101.

The vehicle 101 can include an air compressor 205. The air compressor 205 can move air toward an intended target, e.g., one of the sensors 120. The air compressor 205 can move air through air manifolds 240 to move the air to the sensors 120. For example, the air manifolds 240 can include valves (not shown) that the first computer 105 can instruct to open, allowing air to move through the air manifolds 240 to the sensors 120.

The vehicle 101 can include a windshield wiper 210. The windshield wiper 210 can remove water from a windshield 215. The first computer 105 can actuate the windshield wiper 210 when the second computer 110 detects a precipitation event, e.g., upon detecting rain. The first computer 105 can actuate the windshield wiper 210 until receiving a message from the second computer 110 indicating that the precipitation event has ended.

The vehicle 101 can include a fluid reservoir 220. The fluid reservoir 220 can contain washer fluid to spray onto the sensors 120. The fluid reservoir 220 can be in fluid communication with a reservoir pump 225. The reservoir pump 225 can direct the washer fluid from the fluid reservoir 220 through fluid lines 230 to spray the washer fluid onto, e.g., the sensors 120, the windshield 215, etc. The reservoir pump 225 can spray the washer fluid through sprayers 235 directed toward the windshield 215. The fluid lines 230 can include valves (not shown) that the first computer 105 can actuate to move fluid from the fluid reservoir 220 through the fluid lines 230 to the windshield 215, the rear window 245, and/or the sensors 120.

The vehicle 101 can include a rear window 245 and a rear wiper 250. The rear window 245 allows the occupant to view objects behind the vehicle 101. The rear wiper 250 can be actuated to remove fluid and dirt from the rear window 245. The first computer 105 can actuate the rear wiper 250 to move along the rear window 245 to clean the rear window 245. The reservoir pump 225 can spray washer fluid onto the rear window 245, and the rear wiper 250 can remove the fluid.

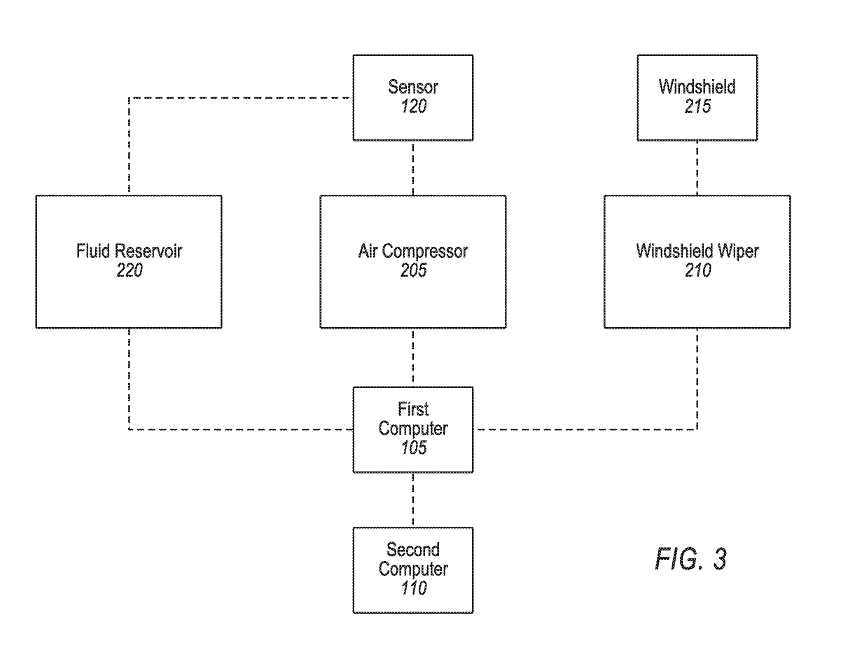

FIG. 3 illustrates the first computer 105 and the second computer 110 communicating with the vehicle components 115. The first computer 105 can be programmed to actuate the reservoir pump 225 and the air compressor 205. The first computer 105 can receive instructions from the second computer 110 to actuate the reservoir pump 225 and the air compressor 205.

The second computer 110 can instruct one or more sensors 120 to collect data 125 and send a message to the first computer 105 based on the data 125. The second computer 110 can further generate instructions executable by the first computer 105 to actuate one or more components 115 to operate the vehicle 101.

The second computer 110 can determine whether the windshield 215 and/or the rear window 245 require cleaning. The second computer 110 can, using known diagnostic techniques, actuate one or more sensors 120 to determine whether the windshield 215 and/or the rear window 245 has dirt and requires cleaning to remove the dirt. For example, the second computer 110 can collect image data 125 (i.e., can capture an image) with the sensors 120 and determine whether there is occluding material (e.g., can detect dirt) on the windshield 215 and/or the rear window 245, using known image processing techniques. The second computer 110 can collect data 125 with the sensors 120 and can determine a quality of the data 125, using known data 125 quality determining techniques, such as determining a light transmittance percentage that is a measure of quality, i.e., an amount of light received by the sensor 120 divided by a maximum amount of light receivable by the sensor 120, for the sensors 120, where the light transmittance percentage decreases when the sensor 120 is occluded with occluding material. The second computer 110 can determine that the sensors 120 require cleaning when the quality of the data 125 is below a quality threshold. For example, if the light transmittance percentage of the sensors 120 is below a transmittance threshold, e.g., 80% transmittance, the second computer 110 can determine that the sensors 120 require cleaning.

The second computer 110 can be programmed to detect a precipitation condition, e.g., rain, snow, etc. The second computer 110 can actuate a sensor 120 that is programmed to detect precipitation and collect precipitation data 125. The second computer 110 can, upon receiving the data 125, determine whether there is a precipitation condition using known precipitation-detecting algorithms. For example, the second computer 110 can detect the precipitation condition when a sensor 120 receives light from an infrared light emitter emitting light onto the windshield 215, and a brightness of the received light is below a brightness threshold. During a precipitation condition, water on the windshield 215 can scatter the emitted infrared light away from the windshield 215, and the sensor 120 receiving the emitted infrared light thus receives less light than was emitted by the infrared light emitter. For example, the second computer 110 can instruct the infrared light emitter to emit a specified amount of light, and a rain sensor 120 can determine an amount of received infrared light. Precipitation can cause the infrared light to escape the vehicle 101, reducing the amount of infrared light received by the rain sensor 120. The second computer 110 can compare the amount of received infrared light to the amount of emitted infrared light to determine a percentage of infrared light received by the rain sensor 120. When the percentage of infrared light received is below a predetermined threshold, e.g., 80%, the second computer 110 can determine that a precipitation condition is occurring.

The second computer 110 can be further programmed to determine a rain speed with one or more sensors 120. As used herein, a “rain speed” is an average speed of raindrops prior to striking the windshield 215. A rain sensor 120 can determine the rain speed by collecting image data of raindrops striking the windshield 215 and, using image processing techniques, estimate an average speed of the raindrops crossing the field of view of the rain sensor 120. The first computer 105 can receive a message from the second computer 110 indicating the rain speed and actuate the windshield wiper 210 and/or the rear wiper 250 at a wiper speed based on the rain speed.

The second computer 110 can determine a reservoir fluid level in the fluid reservoir 220. The fluid reservoir 220 can include a fluid level sensor 120 that can detect the reservoir fluid level in the fluid reservoir 220. The second computer 110 can be programmed to prioritize fluid in the fluid reservoir for cleaning the sensors 120 rather than the windshield 215 and the rear window 245. When the reservoir fluid level in the fluid reservoir 220 is below a reservoir fluid level threshold (e.g., 25%), the second computer 110 can be programmed to suppress actuation of the fluid pumps 225 and to send a message to a specified location, e.g., a repair location, a dealer location, a vehicle washing facility, etc., to refill the fluid reservoir 220. The second computer 110 can be further programmed to move the vehicle 101 to the specified location upon detecting that the reservoir fluid level is below the reservoir level threshold.

The second computer 110 can be programmed to instruct the first computer 105 to actuate the windshield wiper 210 and/or the rear wiper 250. If the second computer 110 detects a precipitation condition, then the sensors 120 may not require washer fluid from the reservoir pump 225 to remove occluding material. The second computer 110 can instruct the first computer 105 to actuate the air compressor 205 to remove rain water and the occluding material from the windshield 215 and/or the rear window 245. The second computer 110 can further instruct the first computer 105 to actuate the windshield wiper 210 to remove rain water from the windshield 215 and/or the rear wiper 250 to remove rain water from the rear window 245.

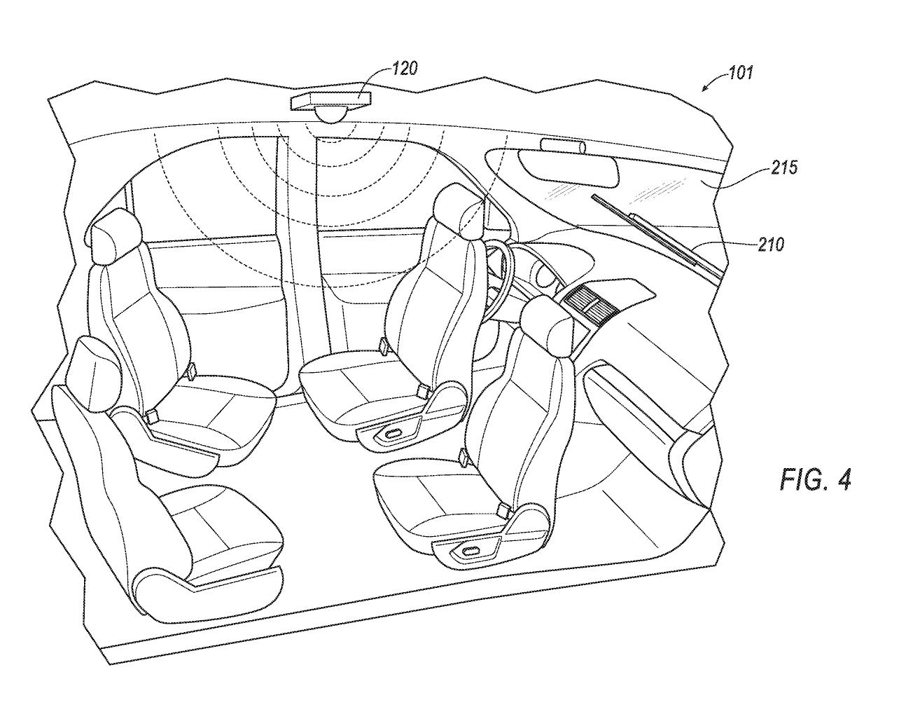

FIG. 4 illustrates an interior of the vehicle 101 with a microphone 120. The microphone 120 can collect sound data 125 from the vehicle 101. For example, the microphone 120 can collect sound data 125 of the windshield wiper 210 moving along the windshield 215. When the windshield 215 has dirt, the windshield wiper 210 can engage with the dirt, causing a squeaking sound or the like as the windshield wiper 210 vibrates while moving along the windshield 215. The sound generated by the windshield wiper 210 can have a plurality of frequencies and a plurality of amplitudes that distinctly identify the sound as being caused by the windshield wiper 210 on the windshield 215.

The microphone 120 can collect data 125 of the frequencies and amplitudes of sounds in the vehicle 101. The first computer 105 can compare the frequency and amplitude data 125 to data 125 of a predetermined sound of a windshield wiper 210 moving along a dirty windshield 215. A “sound” is a vibration in air that can be received by the microphone 120. The microphone 120 can receive the sound as a set of frequency data 125 and a set of amplitude data 125. The sound can include a plurality of frequencies, and each frequency can have an amplitude; the frequency data 125 can include a plurality of frequencies, and the amplitude data 125 can include a plurality of amplitudes. If the frequency data 125 are within a frequency threshold of the predetermined sound and the amplitude data 125 are within an amplitude threshold of the predetermined sound, i.e., the sound “matches” the predetermined sound, the first computer 105 can determine that the sound data 125 comes from the windshield wiper 210 moving along a dirty windshield 215. Furthermore, the first computer 105 can determine that the sound matches the predetermined sound when the number of frequencies of the sound is within a number threshold of the plurality of frequencies of the predetermined sound, as well as satisfying the frequency threshold and the amplitude threshold. The frequency threshold can be a predetermined value that is determined based on specified frequency variations between sounds of windshield wipers 210 on windshields 215, e.g., variations of plus or minus 5%. The amplitude threshold can be a predetermined value based on specified amplitude variations for sounds of windshield wipers 210 traveling through the vehicle 101 cabin to the microphone 120, e.g., variations of plus or minus 10%. The number threshold can be a predetermined value based on specified variations in the number of frequencies between sounds of windshield wipers 210 on windshields 215, e.g., plus or minus 5%.

Alternatively or additionally, the first computer 105 can use known sound-matching algorithms to determine whether the sound matches the predetermined sound. For example, the first computer 105 can use a fuzzy match algorithm, e.g. Soundex, NYSIIS, Metaphone, etc., that converts an analog sound input to a digital output, applies a Fourier transform to convert the digital output into an amplitude output in a time domain and a frequency domain, and compare the amplitude output in the time domain and the frequency domain to amplitude, time, and frequency data of the predetermined sound. If the amplitude output of the sound is within an amplitude threshold, a frequency threshold, and a time threshold of the amplitude, time, and frequency data of the predetermined sound, the first computer 105 can determine that the sound matches the predetermined sound. The amplitude, frequency, and time thresholds can be determined by, e.g., a manufacturer, and can be based on empirical data of sounds from windshield wipers 210 on windshields 215.

The first computer 105 can then actuate one or more components 115 to move the vehicle 101 to a specified location, e.g., a repair location, a dealer location, a vehicle washing facility, etc. The first computer 105 can send a message over a network (e.g., WiFi, DSRC, a cellular network, etc., as is known) to the specified location to schedule arrival of the vehicle 101 for, e.g., maintenance, repair, etc. The message can include a vehicle 101 maintenance request.

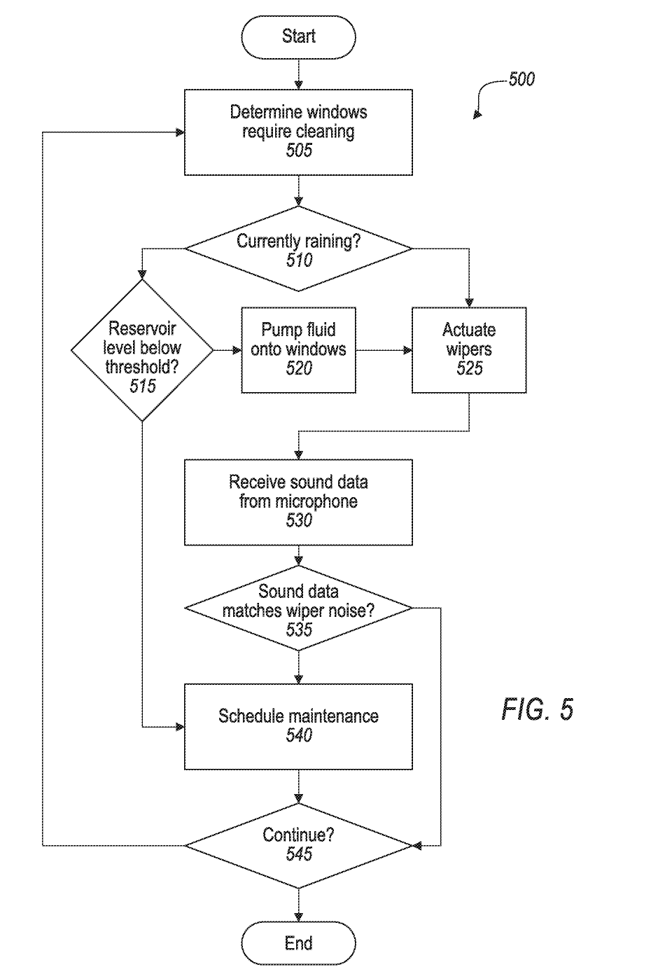

FIG. 5 illustrates an example process 500 for operating the vehicle 101. The process 500 begins in a block 505 in which the second computer 110 determines whether the windshield 215 and/or rear window 245 requires cleaning. As described above, the second computer 110 can actuate one or more sensors 120 and, using known image processing techniques, determine whether the windshield and/or the rear window 245 requires cleaning. For example, the second computer 110 can determine a light transmittance percentage for the sensors 120, and when the light transmittance percentage is below a threshold (e.g., 80%), the second computer 110 can determine that the sensors 120 require cleaning.

Next, in a block 510, the second computer 110 determines whether there is a precipitation condition. As described above, the second computer 110 can actuate a precipitation sensor 120 and, using known techniques, detect a precipitation condition. For example, the second computer 110 can compare an amount of infrared light emitted from an infrared light emitter to an amount of infrared light received by a rain sensor 120 to determine a percentage of infrared light received. If the percentage of infrared light receive dis below a predetermined threshold (e.g., 80%), then the second computer 110 can determine that there is a precipitation condition. If the second computer 110 detects a precipitation condition, the process 500 continues in a block 525. Otherwise, the process 500 continues in a block 515.

In the block 515, the second computer 110 determines whether a reservoir fluid level in the fluid reservoir 220 is below a reservoir fluid level threshold. As described above, the second computer 110 can be programmed to prioritize washer fluid for the sensors 120, and when the fluid reservoir level is below the reservoir level threshold, the fluid reservoir 220 may only have enough washer fluid for the sensors 120 and not the windshield 215 or the rear window 245. If the reservoir fluid level in the fluid reservoir is below the reservoir fluid level threshold, the process 500 continues in a block 540. Otherwise, the process 500 continues in a block 520.

In the block 520, the second computer 110 instructs the first computer 105 to actuate the reservoir pump 225 to spray washer fluid onto the windshield 215 and the rear window 245. The reservoir pump 225 can move washer fluid through the fluid lines 230 to sprayers 235 to spray the washer fluid onto the windshield 215 and/or the rear window 245.

In the block 525, the first computer 105 actuates the windshield wiper 210 and/or the rear wiper 250. As described above, the first computer 105 can determine a speed at which to move the windshield wiper 210 and/or the rear wiper 250 based on a rain speed detected by a sensor 120 actuated by the second computer 110. Furthermore, the first computer 105 can actuate the windshield wiper 210 and/or the rear wiper 250 to remove washer fluid and/or rain water from the windshield 215 and the rear window 245.

Next, in a block 530, the first computer 105 receives sound data 125 from a microphone 120. The sound data 125 can be generated by one or more objects in the vehicle 101 cabin and/or on an exterior of the vehicle 101. For example, the sound data 125 can be generated by the windshield wiper 210 skipping across the windshield 215.

Next, in a block 535, the first computer 105 determines whether the sound data 125 matches data 125 from a predetermined sound of a wiper moving across a glass pane, e.g., a windshield wiper 210 catching on a windshield 215 and generating a squeaking noise. As described above, the sound “matches” the predetermined sound when the frequency data 125 from the sound is with the frequency threshold of the predetermined sound and the amplitude data 125 of the sound is within the amplitude threshold of the predetermined sound. The predetermined sound can be a sound generated when the wiper skips across the pane, indicating a damaged wiper. The first computer 105 can compare frequency data 125 and amplitude data 125 of the sound data 125 to first and second predetermined thresholds, respectively. When the data 125 meets the first and second predetermined thresholds, the first computer 105 can determine that the sound data 125 indicate a damaged wiper (e.g., the windshield wiper 210 or the rear wiper 245) moving across a window (e.g., the windshield 215 or the rear window 250).

In the block 540, the first computer 105 schedules maintenance for the vehicle 101. The first computer 105 can send a message to a specified location (e.g., a repair location) over a network (e.g., a cellular network, WiFi, etc.) indicating that the vehicle 101 requires maintenance, e.g., refilling the fluid reservoir 220, replacing the windshield wiper 210 and the rear wiper 245, etc. The first computer 105 can instruct one or more components 115 to move the vehicle 101 to the specified location.

In the block 545, the first computer 105 determines whether to continue the process 500. For example, the first computer 105 can determine to continue the process 500 when the vehicle 101 is in motion and following a predetermined route. Alternatively, the first computer 105 can determine not to continue the process 500 when the vehicle 101 is at a destination and has shut down. If the first computer 105 determines to continue, the process 500 returns to the block 505. Otherwise, the process 500 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computers 105, 110 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computers 105, 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer including a processor and a memory, the memory storing instructions executable by the processor to:
actuate a windshield wiper on a vehicle;
collect amplitude data and frequency data from a sound of the windshield wiper; and
upon determining that the amplitude data meets a first predetermined threshold and the frequency data meets a second predetermined threshold, actuate a vehicle component to move the vehicle to a specified location.

2. The system of claim 1, wherein the instructions further include instructions to actuate the windshield wiper upon detecting rain.

3. The system of claim 1, wherein the instructions further include instructions to capture an image of a windshield and, upon detecting dirt on the windshield, to actuate the vehicle component.

4. The system of claim 1, wherein the instructions further include instructions to receive instructions from a second computer to actuate the windshield wiper.

5. The system of claim 1, wherein the instructions further include instructions to actuate a fluid pump directed to a windshield.

6. The system of claim 1, wherein the instructions further include instructions to move the vehicle to the specified location upon detecting that a reservoir fluid level is below a reservoir level threshold.

7. The system of claim 1, wherein the instructions further include instructions to send a message including a vehicle maintenance request to the specified location.

8. The system of claim 1, wherein the first predetermined threshold and the second predetermined threshold are based on a sound generated by the windshield wiper on a windshield.

9. The system of claim 1, wherein the instructions further include instructions to actuate a microphone to collect the amplitude data and the frequency data upon detecting rain.

10. The system of claim 1, wherein the instructions further include instructions to receive a message from a second computer indicating a rain speed and to actuate the windshield wiper at a wiper speed based on the rain speed.

11. A system in a vehicle, comprising:
a windshield wiper;
a microphone;
means for actuating the windshield wiper;
means for collecting amplitude data and frequency data from a sound of the windshield wiper with the microphone; and
means for actuating a vehicle component to move the vehicle to a specified location upon determining that the amplitude data meets a first predetermined threshold and the frequency data meets a second predetermined threshold.

12. The system of claim 11, further comprising means for actuating the windshield wiper upon detecting rain.

13. The system of claim 11, further comprising means for capturing an image of a windshield and, upon detecting dirt on the windshield, to actuate the vehicle component.

14. The system of claim 11, further comprising a fluid pump directed toward a windshield and means for actuating the fluid pump.

15. The system of claim 11, further comprising means for moving the vehicle to the specified location upon detecting that a reservoir fluid level is below a reservoir level threshold.

16. The system of claim 11, further comprising means for sending a message including a vehicle maintenance request to the specified location.

17. The system of claim 11, wherein the first predetermined threshold and the second predetermined threshold are based on a sound generated by the windshield wiper on a windshield.

18. The system of claim 11, further comprising means for actuating the microphone upon detecting rain.

19. The system of claim 11, further comprising means for receiving a message from a second computer indicating a rain speed and actuating the windshield wiper at a wiper speed based on the rain speed.

20. A method, comprising:
actuating a windshield wiper on a vehicle;
collecting amplitude data and frequency data from a sound of the windshield wiper; and
upon determining that the amplitude data meets a first predetermined threshold and the frequency data meets a second predetermined threshold, actuating a vehicle component to move the vehicle to a specified location.
